(19) United States
(12) Patent Application Publication
(10) Pub. No.: US 2006/0139743 A1
(43) Pub. Date: Jun. 29, 2006

(54) Semiconductor optical device with beam focusing

(76) Inventors: John Haig Marsh, Glasgow (GB); Stephen Najda, Glasgow (GB)

Correspondence Address: DASPIN & AUMENT, LLP, 210 WEST 22ND STREET, SUITE 102, OAK BROOK, IL, 60523, US

(21) Appl. No.: 10/536,936

(22) PCT Filed: Nov. 20, 2002
(86) PCT No.: PCT/GB03/04906

§ 371 Date: Feb. 17, 2006

(30) Foreign Application Priority Data
Nov. 20, 2002 (GB) 0227089.0

(51) Int. Cl. H01S 3/00

(52) U.S. Cl. 359/344

(57) ABSTRACT

An integrated optical device formed in a semiconductor substrate incorporated an integral lens element in the substrate for providing focusing of the output beam. The device includes an optically active region for generating and confining optical radiation and having an output end for emitting an output beam from the optically active region; and a lens region adjacent the output end which has an increased band gap to the adjacent substrate material and is shaped to provide a lens effect on said output beam. The optically active region forms a cavity having a longitudinal axis, and the lens region extends along the longitudinal axis and has a lateral extent that varies as a function of distance along the longitudinal axis.

The present invention relates to semiconductor optical devices, and in particular to optical output structures for such devices.

An edge emitting semiconductor laser device generally emits an elliptical far-field optical output with a typical vertical to horizontal aspect ratio of approximately 3:1. Therefore, coupling the elliptical output of an edge emitting laser into a glass fibre or other optical waveguide is typically not very efficient.

For example, butt coupling a laser against a glass fibre or waveguide typically gives a coupling efficiency of approximately 30%. The far field of the laser can be further reduced to slightly improve the coupling efficiency using a number of structures generally known in the art, but this is usually at the expense of other laser parameters such as threshold.

The problem is particularly acute for single-mode optical coupling where coupling efficiencies are particularly sensitive to misalignment due to thermal cycling or vibration in the assembled, coupled device.

To improve the coupling efficiency, the prior art generally suggests the use of a lens (or a system of lenses) that can be adopted to collect and focus the laser light into the optical fibre or waveguide. In the ideal case, a system of lenses (for example, up to four lenses) is required to adjust the laser output from an elliptical profile to a circular profile and focus the output beam to a tight spot.

However, a system of lenses is often impractical. There are numerous difficulties and additional costs in packaging the assembled device and usually cost is an important factor for many applications.

Alternatively, a commonly adopted solution in the prior art is to provide a single lens element machined onto the end of the optical fibre, onto which the laser beam is directed, giving a coupling efficiency of up to approximately 80%. However, this system cannot be easily adapted to other types of optical waveguides (eg. those integrated onto a semiconductor substrate) and is expensive. As integration on chip becomes important, the number of devices on chip, the footprint and the cost are important issues, and lens fibre becomes prohibitively expensive and bulky.

In another prior art solution, free space coupling may be achieved. For example, a holographically etched or anamorphic lens can be used to achieve coupling efficiencies of the order of 60%. Arrays of microlenses have been considered for coupling arrays of lasers into waveguide arrays. The laser light is directed onto a standing lens and then focused into the fibre or waveguide, resulting in two air gaps and therefore lower efficiency. However, complicated packaging solutions are required to achieve such coupling efficiencies in a manufactured product.

It is therefore desirable to provide a semiconductor laser or other optical device having an optical output that can be efficiently coupled into an optical fibre or other optical waveguide without the need for an external lens.

According to one aspect, the present invention provides an integrated optical device comprising a semiconductor substrate in which is formed:

an optically active region for generating and confining optical radiation and having an output end for emitting an output beam from the optically active region;

a lens region positioned to receive the output beam from the output end, the lens region having a reduced refractive index and/or an increased band gap to adjacent substrate material and being shaped to provide a lens effect on said output beam.

According to another embodiment, the present invention provides a method of forming an integrated optical device comprising the steps of:

forming an optically active region for generating and confining optical radiation in a semiconductor substrate, the optically active region having an output end for emitting an output beam from the optically active region; and

forming a lens region in the substrate positioned to receive the output beam from the output end, the lens region having a reduced refractive index and/or an increased band gap to adjacent substrate material and being shaped to provide a lens effect on said output beam.

Embodiments of the present invention will now be described by way of example and with reference to the accompanying drawings in which:

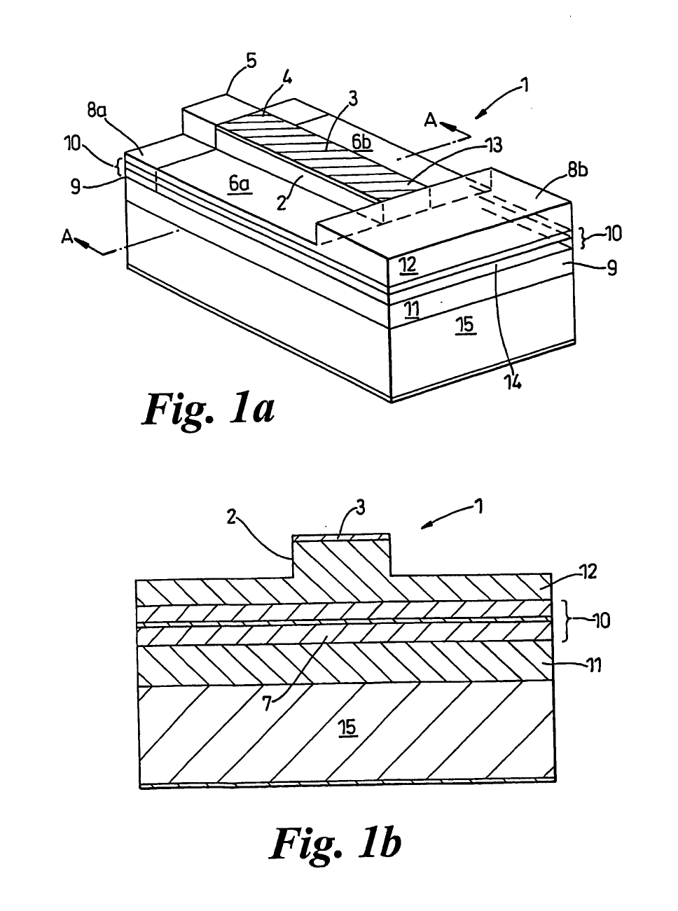

FIG. 1a is a schematic perspective diagram of a conventional semiconductor laser device having an elliptical optical output and having quantum well intermixed regions adjacent the end facets to reduce the risks of catastrophic optical damage;

FIG. 1b is a cross-sectional view on line A-A of FIG. 1a;

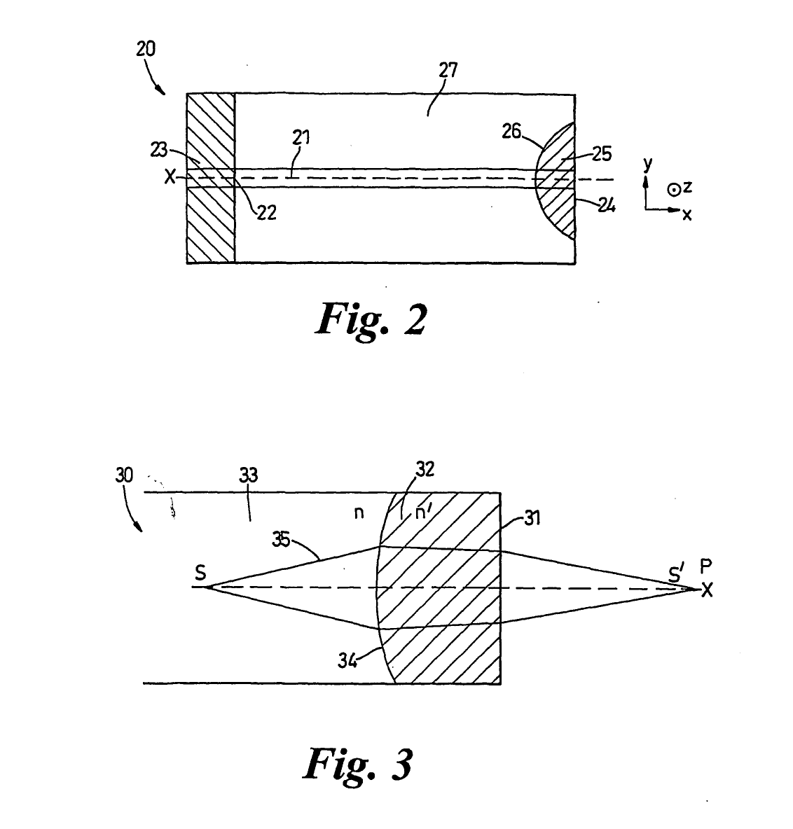

FIG. 2 is a schematic plan view of a semiconductor laser device having an integrated optical lens at an output facet of the device;

FIG. 3 is a schematic plan view of a device similar to that of FIG. 2, illustrating the optical focusing effects of the integrated optical lens;

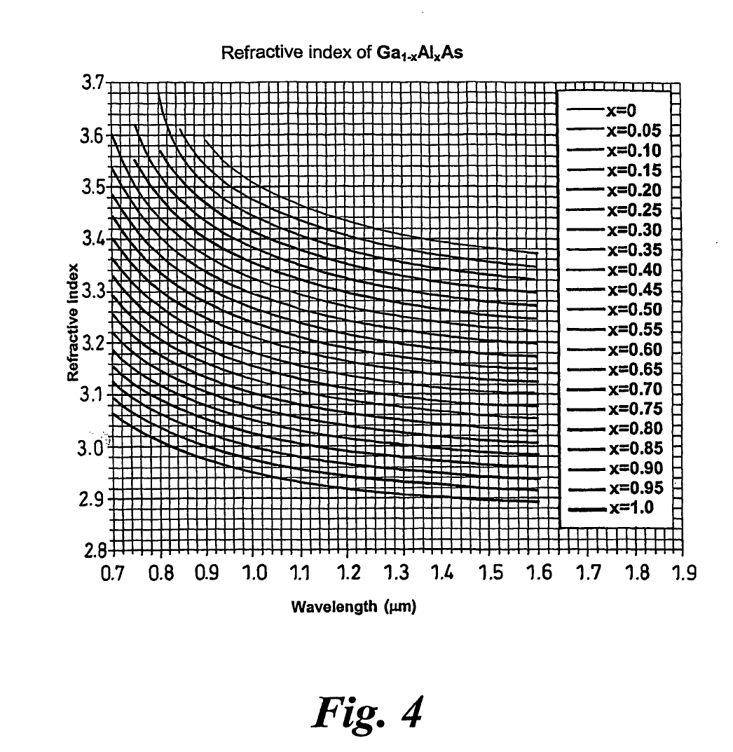

FIG. 4 is a graph illustrating the variation in refractive index against optical wavelength, in Ga₁₋ₓAlₓAs, as a function of the Ga:Al ratio, x;

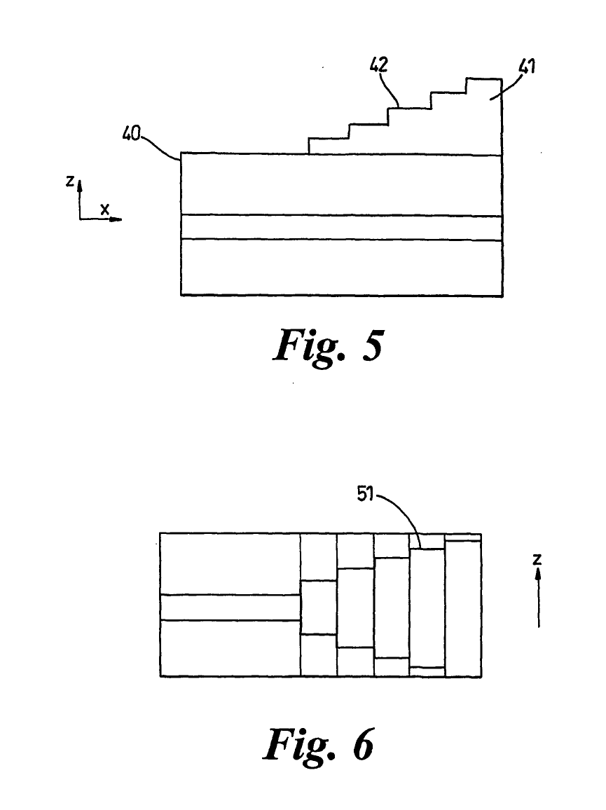

FIG. 5 is a schematic cross-sectional side view of a semiconductor laser device having an integrated optical lens formed by a thickness graded layer of silica on the device surface;

FIG. 6 is a schematic diagram showing the band gap resulting from quantum well intermixing by thermal annealing of the structure of FIG. 5;

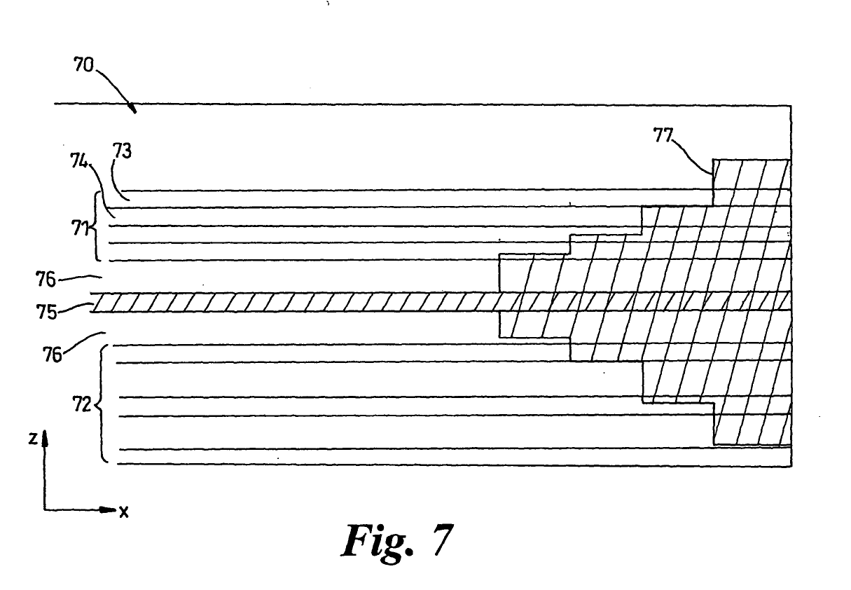

FIG. 7 is a schematic cross-sectional side view of a layered superlattice structure suitable for forming an integrated optical lens;

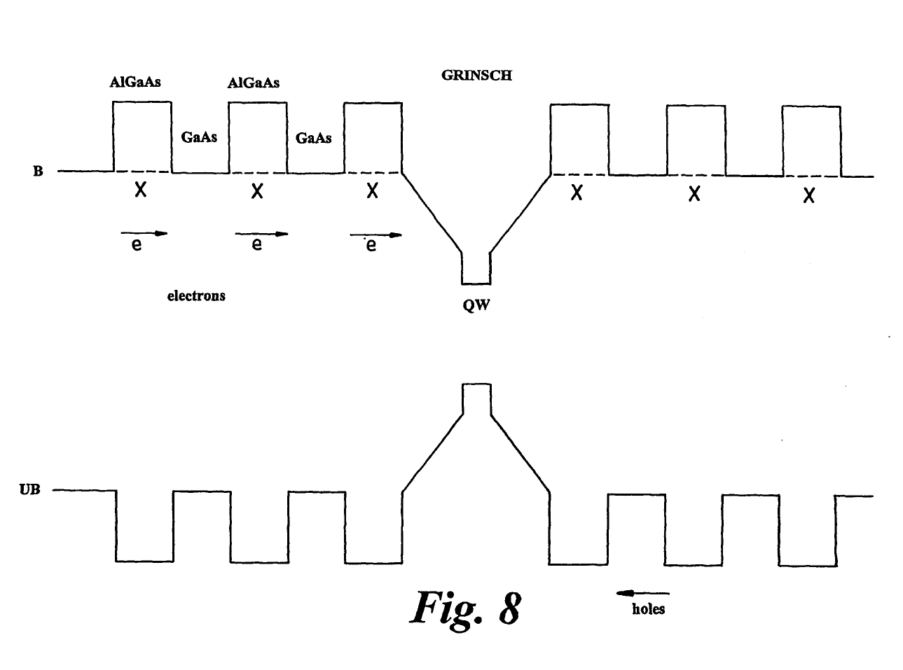

FIG. 8 is a schematic diagram of the band gap resulting from the structure of FIG. 7;

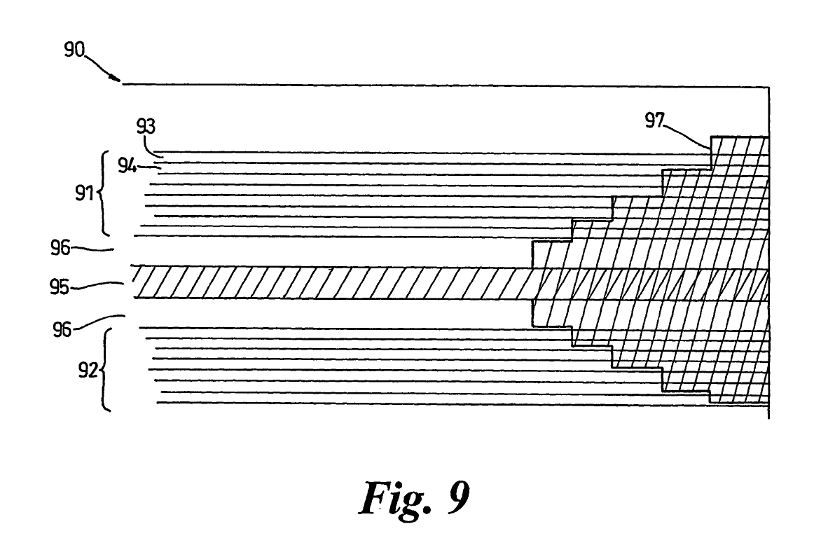

FIG. 9 is a schematic cross-sectional side view of a layered short-period superlattice structure suitable for forming an integrated optical lens;

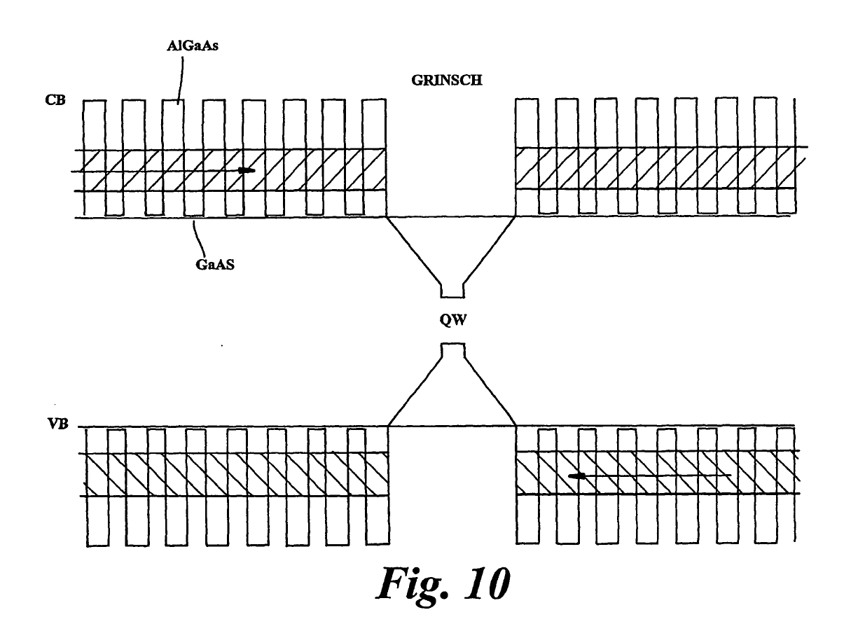

FIG. 10 is a schematic diagram of the band gap resulting from the structure of FIG. 9;

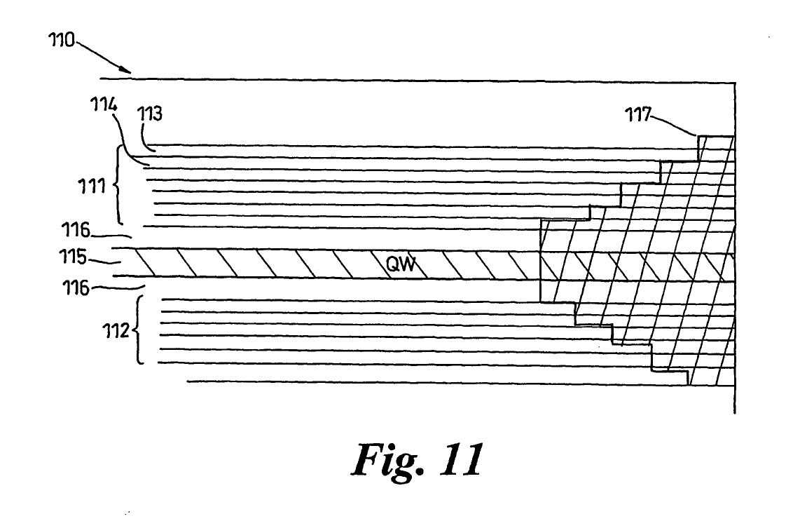

FIG. 11 is a schematic cross-sectional side view of a graded band gap, layered superlattice structure suitable for forming an integrated optical lens;

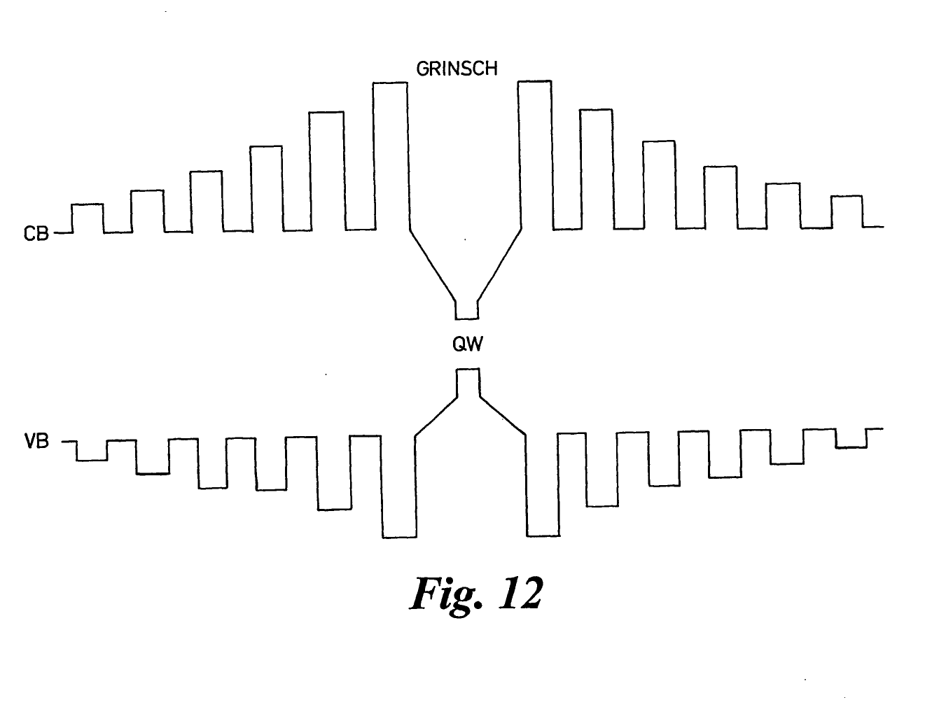

FIG. 12 is a schematic diagram of the band gap resulting from the structure of FIG. 11;

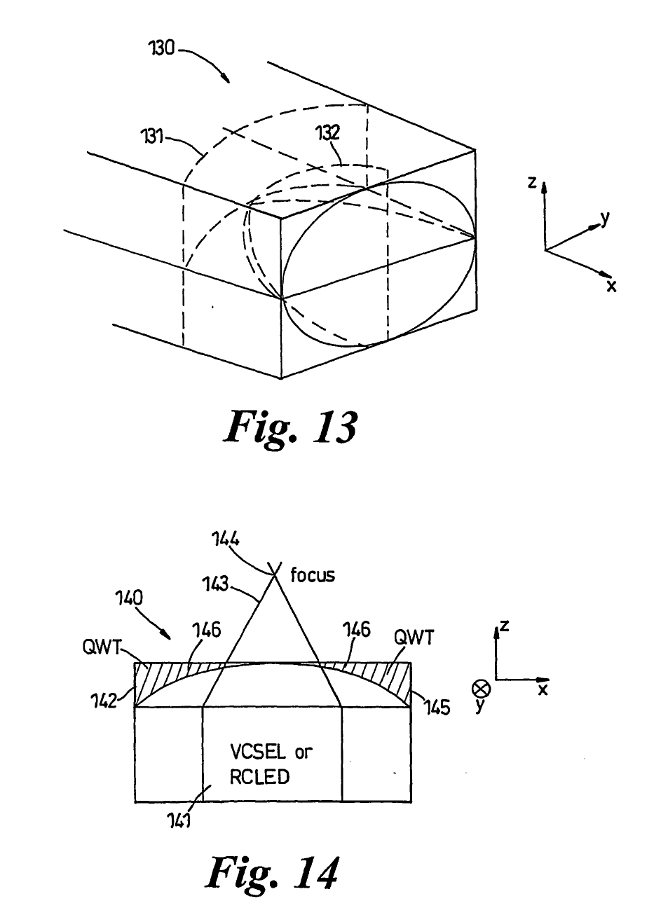

FIG. 13 is a schematic perspective view of a semiconductor laser device having an integrated, three dimensional optical lens structure; and

FIG. 14 is a schematic side view of a vertical cavity surface emitter device incorporating an integrated optical lens at its output facet.

Referring firstly to FIGS. 1a and 1b, there is shown a conventional semiconductor laser device, generally designated 1, suitable for modification in accordance with the present invention. The device 1 comprises an optical ridge waveguide 2 and at least one electrical contact 3 extending along part of the length of the waveguide 2.

One end 4 of the electrical contact 3 is spaced from a respective end 5 of the optical waveguide 2. As shown, the optical waveguide 2 is a ridge waveguide laterally bounded by etched portions 6a, 6b, and the electrical contact 3 is provided along the top of the ridge waveguide. However, other types of waveguide and contact are known, which are also applicable to the present invention. For example, the etched portions 6a, 6b may comprise compositionally disordered or quantum well intermixed portions bounding sides of the optical waveguide 2.

An optically active or gain region 7 lies beneath optical waveguide 2. An optically passive region 8a, 8b is provided at each end of the optical waveguide. Generally, the optically passive regions 8 have a width the same as the waveguide, as shown at 8a, the non-output end of the optically active region in FIG. 1a. In some circumstances, the optically passive region 8b may be broader than the optical waveguide 2 so that, in use, an optical output of the optical waveguide 2 diffracts as it traverses the optically passive region 8.

In this way, the optical output is expanded so that the intensity of light impinging on an output facet 9 of the device 1 is reduced, thereby reducing the risk of catastrophic optical mirror damage.

The optically active and passive regions 7, 8 are provided within an optical guiding or core layer(s) 10 between first and second (lower and upper) optical cladding confining layers 11, 12. Typically, the first cladding layer 11 and the second cladding layer 12 each have a refractive index that is lower than that of the guiding layer(s) 10 to provide waveguiding properties.

The ridge waveguide 2 is formed in at least the second cladding layer 12 and extends longitudinally from the first end 5 of the device 1 to a position 13 between the first end 5 and a second end 14 of the device 10. The second end 14 comprises an output of the semiconductor laser device 1. The output facet may include an anti-reflective coating which, in combination with the passive region 8b, provides a non-absorbing mirror.

The optical guiding (core) layer(s) 10 comprise an active lasing material layer including a Quantum Well structure. The optically passive regions 8a, 8b include a compositionally disordered semiconductor material provided within the guiding layer 10, having a larger band-gap than the guiding layer 10.

The device 1 is of a monolithic construction including a substrate 15, upon which the other layers may be grown by conventional III-V semiconductor growth techniques, eg Molecular Beam Epitaxy (MBE) or Metal Organic Chemical Vapour Deposition (MOCVD). The compositionally disordered lasing material may be achieved through Quantum Well Intermixing (QWI) according to known techniques.

The semiconductor laser device may be fabricated in a Gallium Arsenide (GaAs) materials system such as Aluminium Gallium Arsenide (AlGaAs) material system, and may therefore lase at a wavelength of between 600 and 1300 nm, and preferably around 980 nm. The guiding layer 10 may substantially comprise in Indium Gallium Arsenide (InGaAs). Alternatively, the device 10 may be fabricated in an Indium Phosphide (InP) materials system, eg operating in a wavelength range of 1200 to 1700 nm.

In accordance with the present invention, the laser device described above may be modified to provide a focusing element. As shown in the plan view of FIG. 2, a semiconductor laser device 20 includes a ridge waveguiding structure 21 which effectively defines a longitudinal axis (x) of the optical device 20, and in particular defines a longitudinal axis of the optically active region or cavity of the laser device. At one end 22 of the optically active region there is formed a non-absorbing mirror 23 which preferably reflects substantially all of the optical radiation generated within the cavity.

The non-absorbing mirror 23 is preferably formed using a quantum well intermixing process to locally increase the band gap of the semiconductor substrate using techniques known in the art. An advantage of impurity free quantum well intermixing techniques to form non-absorbing mirrors is that they allow the band gap to be increased at the facet ends of a semiconductor laser to avoid catastrophic optical damage to the facet allowing the formation of high power, long lifetime devices. However, other mirror structures could be used also as known within the art.

At the output end 24 of the laser device 20 there is formed a lens region 25 within the substrate and/or one or more of the optical cladding/guiding layers thereon, which will all be referred to hereinafter as “substrate”. The lens region 25 is adapted to provide a focusing effect on the radiation emitted from the laser device and comprises a region of substrate having a reduced refractive index from the adjacent substrate, and in particular relative to the optically active region or cavity.

To this end, the lens region 25 is preferably defined as a shaped quantum well intermixed (QWI) region of larger band gap. The shaped profile of the lens region is any suitable shape that provides a focusing effect on the output beam. The focusing effect may be used to enable the beam shape to be adapted for better coupling into an optical fibre or any suitable waveguide structure (not shown).

In one arrangement as shown, the lens region 25 extends along the longitudinal (x) axis and has a lateral extent (ie. a width and/or a depth) that varies as a function of distance along the longitudinal axis, x. As described throughout the present specification and shown in the drawings, the expression “width” refers to the dimension along the y axis (as shown in FIG. 2), and the expression “depth” refers to the dimension along the z axis, into the substrate (as best shown in FIG. 5).

More particularly, in the preferred embodiment, the variation in lateral extent of the lens region as a function of distance along the longitudinal axis defines a curved profile to produce the required focusing effect. A single step change in width of the waveguide, as is provided in the prior art arrangement of FIG. 1a does not result in a focusing effect.

In the preferred embodiments, the lens region 25 is formed using quantum well intermixing (QWI) to locally increase the band gap and thereby decrease the refractive index of the substrate. More preferably, the QWI process used can be an impurity free QWI process. Use of a QWI technique to form the integrated lens region in the substrate enables the achievement of superior spatial resolution not available with other techniques for locally modifying refractive index in the substrate. In addition, the preferred impurity free QWI process avoids introduction of impurities into the substrate which would otherwise cause optical absorption which can catastrophically damage the facet and hence give rise to device failure.

The shaped lens region 25 at the output facet 24 both avoids catastrophic optical damage in the device and provides the requisite lens effect on the output beam to improve the coupling efficiency.

The formation of the lens region 25 integrated into the same substrate as the laser cavity can be effected in a straightforward manner using QWI processing techniques and this avoids the need for a free space lens coupling system between the laser and optical waveguide or fibre. This may offer many benefits, including substantial cost savings, reduction in the complexity of the packaging, facilitation of relaxed alignment tolerances, improvement in yield and also in device lifetime.

As will be described in the following embodiments, the lens region may be adapted to perform focusing of the beam in one or both of the horizontal and vertical axes. The lens shaping may also reduce cavity-coupling effects that can occur due to quantum well intermixing and hence improve the spectral output of the laser.

The use of an impurity free quantum well intermixing process is particularly suitable for increasing the band gap (ie. decreasing the refractive index) in a controlled manner.

As shown in FIG. 2, in the preferred embodiment, the lens region 25 is formed by photolithographically defining a radius of curvature 26 in a silica layer deposited over the substrate during the QWI process. A thermal anneal process is then used to achieve the desired intermixing of the quantum well region, and hence reduction in refractive index. By this process method, the horizontal component of the output beam can be brought to a focus, due to refraction at the curved surface 26. The focal length is determined by the radius of curvature and refractive index difference between the intermixed region 25 and the non-intermixed region 27. By analogy to simple lens design, a plano-convex lens can be fabricated.

The expected focusing effect is shown in FIG. 3. In this example, the ridge laser 30 has a ridge width dimension of approximately 2 microns to restrict the transverse mode to single mode. At the output facet end 31 of the device 30, the intermixed region 32 has a spherical surface 34 with a radius of curvature of approximately 20 microns. The area within the radius of curvature is intermixed to increase the band gap by approximately 100 meV in, for example, a 980 nm laser consisting mainly of Al_{0.32}Ga_{0.68}As. A 100 meV increase in the AlGaAs band gap is equivalent to increasing the Al mole fraction by approximately 10%. A 100 meV increase in the AlGaAs band-gap due to QWI corresponds to a refractive index change of approximately 2.2%.

A wavefront is generated in the active region 33 of the device 30 and is refracted at the spherical surface 34 of radius R at the intermixed region 32. A ray 35 from point s incident at an angle to the radius of curvature is refracted at an angle and intersects at a focus point P at a distance s′. The small-angle approximation gives a simple formula for image formation by a spherical refracting surface as:
n/s+n′/s′=(n′−n)/R
where n is the refractive index of the non-intermixed region 33, s is the focal point within the optically active cavity, n′ is the refractive index of the intermixed region 32, s′ is the focal point outside the output facet and R is the radius of curvature of the lens region surface 34.

Thus, for the example of R=20 microns, and a refractive index of n=3.23 for the non-intermixed semiconductor and n′=3.16 for the intermixed region of semiconductor, and for a cavity length to the non-absorbing mirror 23 of s=100 microns gives a focus at s′=110 microns. This calculation gives a first approximation for the focal length and does not include a factor for the semiconductor/air interface, which can readily be factored into the calculation if necessary.

The semiconductor laser 20, 30 can also be designed to include layers of AlGaAs in the substrate with a higher aluminium mole fraction so that the refractive index contrast is greater and hence a larger focusing can be obtained. FIG. 4 illustrates how the refractive index changes with band gap for different stoichiometric ratios of Ga to Al.

The foregoing example illustrates how the lens region 25, 32 may vary in width as a function of distance along the longitudinal axis x, the width being defined as the axis orthogonal to the longitudinal axis and parallel to the surface of the substrate (shown as they axis).

Alternatively, and/or in addition, the refractive index of the lens region can also be adapted to vary in depth as a function of distance along the longitudinal axis, the depth being defined as the axis orthogonal to both the longitudinal axis and the surface of the substrate. This can be achieved by grading the refractive index in the crystal growth direction, by selectively grading the degree of intermixing, to give an index radius of curvature in the vertical (z) direction.

In one embodiment as shown in FIG. 5, the selective grading of intermixing can be achieved by depositing a layer of silica 41 followed by thickness grading the layer of silica to form a “staircase” 42. The thickness grading can be achieved by photolithographic masking and etching of the silica layer 41. The device is then thermally annealed under optimum conditions for intermixing to give a graded band gap, as shown in FIG. 6.

The band gap shift 51 is determined in part by the depth of the overlying silica layer 41 during the intermixing process. Thus, in this manner, a radius of curvature in refractive index change can be achieved according to the band gap variation.

With reference to FIGS. 7 and 8, a further embodiment of optical device 70 increases the optical overlap (ie. the extent to which the optical field extends into the cladding region), and hence the refractive index contrast, by way of a superlattice structure 71, 72 in the cladding regions of the device. In this arrangement, the cladding regions 71, 72 are formed with a plurality of layers of semiconductor material in which the refractive index varies periodically in the z direction. Preferably, the plurality of layers comprise alternating layers 73, 74 of AlGaAs and GaAs respectively.

Preferably, the quantum well active region 75 is sandwiched on each side by a graded index GRINSCH structure 76. The GRINSCH structure 76 and superlattice structure 71, 72 provide enhanced spatial confinement of the output beam.

Following a suitable anneal process, the quantum well intermixing results in a refractive index change 77 in a staircase profile as shown.

To improve carrier injection into the active region and thereby achieve a higher efficiency device, the AlGaAs band-gap can be aligned such that transport through the AlGaAs X-band can be achieved, using techniques known in the art.

With reference to FIGS. 9 and 10, in a further arrangement, a short-period superlattice 91, 92 is formed such that band overlap between superlattice layers creates a mini-band allowing transport of carriers and hence a low resistance device.

The short period superlattice 91, 92 is formed with a plurality of layers 93, 94 of semiconductor material in which the refractive index varies periodically in the z direction. Preferably, the plurality of layers comprise alternating layers 93, 94 of AlGaAs and GaAs respectively.

Preferably, the quantum well active region 95 is sandwiched on each side by a graded index GRINSCH structure 96. The GRINSCH structure 96 and superlattice structure 91, 92 provide enhanced spatial confinement of the output beam.

Following a suitable anneal process, the quantum well intermixing results in a refractive index change 97 in a staircase profile as shown.

With reference to FIGS. 11 and 12, in a further arrangement, a superlattice 111, 112 comprises a plurality of graded layers 113, 114 such that band gap maxima of the periodic band gap (and thus the minima of the refractive index) vary as a function of the z direction.

Preferably, the plurality of layers comprise alternating layers 113, 114 of AlGaAs and GaAs respectively, in which the stoichiometric ratio of the AlGaAs varies to provide the variation in band gap maxima.

Preferably, the quantum well active region 115 is sandwiched on each side by a graded index GRINSCH structure 116. The GRINSCH structure 116 and superlattice structure 111, 112 provide enhanced spatial confinement of the output beam.

Following a suitable anneal process, the quantum well intermixing results in a refractive index change 117 in a staircase profile as shown.

With reference to FIG. 13, it will be understood that both the variations in depth and in width of the refractive index can be combined in one structure to obtain an index radius of curvature in both the x-y plane (Δn boundary 131) and in the x-z plane (Δn boundary 132) to give a three dimensional plano-convex lens shape within the substrate and/or cavity. The radius of curvature is chosen for the particular optical coupling requirement.

Although the preferred embodiments describe an edge emitting semiconductor laser device, the principles of the integrated lens region at an output end of the device can be applied also to vertical cavity emitters such as vertical cavity surface emitting lasers (VCSELs) or resonant cavity light emitting diodes (RCLEDs).

FIG. 14 illustrates an exemplary vertical cavity emitter 140 which has an active region 141 sandwiched between two mirrors (one of which is shown at 142) to create a microcavity. The output beam 143 from a vertical cavity structure is generally spherically divergent. The present invention allows collimate or focusing of the output beam from a vertical cavity device as shown, eg. to a focal point 144. The surface region 145 of the VCSEL or RCLED device 140 is provided with a graded index region 146 which varies in width as a function of distance along the longitudinal axis which axis is, in the case of a vertical emitter, in the vertical direction indicated as z in FIG. 14. This focuses the output light in either or both the x and y directions.

In the preferred embodiments described above, the lens region 25 (or 146) is preferably immediately adjacent to the optically active region structure 21 (or 141), ie. the two structures share a common boundary. However, it is possible that the two structures could be separated by some intermediate waveguiding structure, which may be optically passive or active. Regardless of the nature of any intermediate waveguiding structure, the optical output beam of the optically active region is directed into the lens region.

In the preferred embodiments described above, the lens region 25 (or 146) is preferably entirely optically passive. However, the lens region may also comprise an optically active structure, providing that a refractive index profile is maintained to produce the required focusing effect.

Other embodiments are intentionally within the scope of the accompanying claims.

1. An integrated optical device comprising a semiconductor substrate in which is formed:
an optically active region for generating and confining optical radiation and having an output end for emitting an output beam from the optically active region;
a lens region positioned to receive the output beam from the output end, the lens region having a reduced refractive index and/or an increased bandgap to adjacent substrate material and being shaped to provide a lens effect on said output beam.

2. The device of claim 1 in which the optically active region forms a cavity having a longitudinal axis, the lens region extending along the longitudinal axis and having a lateral extent that varies as a function of distance along said longitudinal axis.

3. The device of claim 2 in which the depth of the lens region varies as a function of distance along the longitudinal axis, the depth being defined as the axis orthogonal to both the longitudinal axis and the surface of the substrate.

4. The device of claim 2 in which the width of the lens region varies as a function of distance along the longitudinal axis, the width being defined as the axis orthogonal to the longitudinal axis and parallel to the surface of the substrate.

5. The device of claim 4 in which both the depth and width of the lens region varies as a function of distance along the longitudinal axis, depth being defined as the axis orthogonal to both the longitudinal axis and the surface of the substrate.

6. The device of claim 1 in which the lens region is an optically passive region.

7. The device of claim 1 in which the lens region includes an optically active structure.

8. The device of claim 1 in which the optically active region and the lens region are immediately adjacent one another.

9. The device of claim 1 further including an intermediate waveguiding structure between the output end of the optically active region and the lens region.

10. The device of claim 3 in which the lens region comprises a quantum well intermixed region, the degree of quantum well intermixing varying as a function of distance along the longitudinal axis.

11. The device of claim 10 further including a layer of material of varying depth over the lens region, the material enhancing quantum well intermixing in the substrate material in which the lens is formed.

12. The device of claim 1 further including a superlattice structure having a periodic variation in refractive index along an axis orthogonal to the surface of the device, the superlattice extending through the optically active region and the optically passive region.

13. The device of claim 12 in which the superlattice structure further includes band overlap between layers within the superlattice to create a mini-band for transport of carriers.

14. The device of claim 12 in which the superlattice structure further provides a variation in periodic band gap maxima as a function of distance along an axis orthogonal to the surface of the device.

15. The device of claim 1 in which the optical device is a laser.

16. The device of claim 15 in which the optical device is an edge emitting laser.

17. The device of claim 1 in which the device is a vertical cavity emitter having a cavity whose longitudinal axis extends substantially orthogonally to the surface of the device.

18. The device of claim 17 in which the lens region is formed in a surface layer of the device.

19. A method of forming an integrated optical device comprising the steps of:
forming an optically active region for generating and confining optical radiation in a semiconductor substrate, the optically active region having an output end for emitting an output beam from the optically active region;
forming a lens region in the substrate positioned to receive the output beam from the output end, the lens region having a reduced refractive index and/or an increased bandgap to adjacent substrate material and being shaped to provide a lens effect on said output beam.

20. The method of claim 19 in which the step of forming the lens region comprises the steps of:
depositing a layer of material onto the substrate, the material being adapted to enhance or suppress quantum well intermixing in an underlying semiconductor substrate;
photolithographically defining said material to provide a quantum well intermixing cap having a lateral extent that varies as a function of distance along a longitudinal axis of said optically active region;
thermally annealing the substrate to locally modify the band gap according to the extent of the deposited material.

21. The method of claim 19 in which the step of forming the lens region comprises the step of:
depositing a layer of material onto the substrate, the material being adapted to enhance or suppress quantum well intermixing in an underlying semiconductor substrate;
photolithographically defining said material to provide a quantum well intermixing cap having a layer thickness that varies as a function of distance along a longitudinal axis of said optically active region;
thermally annealing the substrate to locally modify the band gap according to the extent and depth of the deposited material.

22. The method of claim 21 in which the depth of the lens region varies as a function of distance along the longitudinal axis, the depth being defined as the axis orthogonal to both the longitudinal axis and the surface of the substrate.

23. The method of claim 20 in which the width of the lens region varies as a function of distance along the longitudinal axis, the width being defined as the axis orthogonal to the longitudinal axis and parallel to the surface of the substrate.

24. The method of claim 21 in which both the depth and width of the lens region varies as a function of distance along the longitudinal axis.

25. The method of claim 19 in which the step of forming the lens region further comprises forming said lens region as an optically passive region.

26. The method of claim 19 in which the step of forming the lens region further comprises forming at least part of the lens region as an optically active region.

27. The method of claim 19 further including the step of forming the optically active region and the lens region immediately adjacent one another.

28. The method of claim 19 further including the step of forming an immediate waveguiding structure between the output end of the optically active region and the lens region.

29. The method of claim 25 further including the step of forming a superlattice structure having a periodic variation in refractive index along an axis orthogonal to the surface of the device, the superlattice extending through the optically active region and the optically passive region.

30. (canceled)
